(19) United States
(12) Patent Application Publication
(10) Pub. No.: US 2011/0277799 A1
(43) Pub. Date: Nov. 17, 2011

(54) CART WASHING DEVICE AND CLEANING SYSTEM

(76) Inventors: Marlin Harold THOMPSON, Boones Mill, VA (US); James John Wilmouth, SR., Salem, VA (US); Edward Anthony Giuffre, JR., Wirtz, VA (US)

(21) Appl. No.: 12/781,289

(22) Filed: May 17, 2010

(51) Int. Cl. B08B 9/00

(52) U.S. Cl. 134/167 R

(57) ABSTRACT

The present invention is a device and system for cleaning and washing containers, including open containers such as carts or tanks, and closed containers such as casks and drums, for virtually any industry. The device is used in combination with any hot water pressure washer. The container washing device and system according to the invention is able to wash a container in under one minute using less than 3.2 gallons of water. The containers are loaded in a horizontal position onto a platform or portable table while maintaining a low profile. A wash head driver by a power head translates in and out of the cart to bring a turbo nozzle in close proximity with all interior cart surfaces. Advantageously a gear train in the wash head has a tooth ratio that produces a non-repeating path for the wash head which rotates the turbo nozzle in two different planes, while reciprocating linearly in and out of the container. According to the invention a custom design wash system can be provided specific to an operator's needs.

### BACKGROUND OF THE INVENTION

### Field of the Invention

The present invention is a device and system for cleaning containers, open (carts or tanks) or closed (casks and drums), for virtually any industry. The device is used in combination with any hot water pressure washer.

OBJECT AND SUMMARY OF THE INVENTION

The object of the invention is to provide a cart washing device and system that includes a semi-automated unit as well as a fully-automated unit that will clean containers from 5 gallon to 140 gallon capacity. The cart washing device and system according to the invention is able to wash a cart in under one minute using less than 3.2 gallons of water.

It will be understood that “cart” refers to any container having an interior surface, such as open carts or tanks or closed casks and drums.

The carts are loaded in a horizontal position while maintaining a low profile. This permits a wash head to translate in and out of the cart to bring a turbo nozzle in close proximity with all interior cart surfaces. Advantageously a gear train in the wash head has a tooth ratio that produces a non-repeating path for the wash head.

The cart washing device can be used with any hot water pressure washer providing 3.5 to 8 GPM at 2000-3000 psig. According to the invention a custom design wash system can be provided specific to an operator's needs.

A unique feature of the cleaning system is that it will clean any container in less time and for less unit cost than any product in industry. The containers are cleaned while horizontal to keep any water away from the wash head drive mechanism. The system can be hand held with manual operation, semi-automated or fully automated to meet customer requirements. The manual system includes a table for holding the container in place while being cleaned. Low water volume usage per cycle allows the system to be truck mounted for mobile applications.

Key to the performance of the cart washing device is the motorized (24 VDC) extended scanning wand sweeping a vertical plane through a set of bevel gears while the motor drives it horizontally, and the unique design of the wash head. Water enters through a housing and flows in the annular space between a stainless steel tube and a slowly rotating stainless steel shaft. The water flows to a cross-drilled hole in the shaft into a main housing that rotates with the shaft. A stationary brass bevel pinion gear is mated with a larger rotating brass bevel gear attached to a turbo nozzle. The gears are integral to the upper housing and the nozzle housing. They are covered by a plastic housing to prevent debris from entering the gear train. Before entering the turbo nozzle, the water flows through cross-holes drilled in the main housing into the nozzle housing. The special number of teeth in the pinion and gear produce a non-repeating path of the turbo nozzle in two planes to clean every portion of the inside surface of the container. A shortened version of the wash head using conventional 15° nozzles (without the turbo nozzle) can be used for cleaning the interior of casks and drums because the head will pass through a 2 inch bung opening found on wine casks and steel drums.

Rotation of the wash head is accomplished by a DC electric motor, AC electric motor, air motor, or water motor at an optimum speed of 12-14 rpm connected through a flexible spider coupling. Another unique feature of the system that enhances performance is that the wash head translates in and out of the container manually or mechanically driven to reduce wash time and improve cleaning efficiency.

Several safety features are provided to prevent high pressure spray from striking the operator. Interlocks for operator safety are built into both the manual and automated systems to prevent high pressure hot water from flowing unless the container to be cleaned is in place. The automated system sequence is initiated by an operator station using buttons and selector switches. A custom programmable logic controller actuates electro-pneumatic valves to direct air cylinders, with flow control valves for velocity control. The automated system may also include separate cabinets for the electronics and the container being cleaned so water used for cleaning can be collected and sent to a defined drain area.

Venturi aspirator valves are used in the system to introduce detergents, disinfectants, and/or deodorants during the wash cycle. These can be controlled in a timed cycle from the operator station on the automated system or controlled by the operator on the manual system.

Ease of maintenance is another characteristic of the design. “O” rings, (the most frequent maintenance item) can be replaced in a few minutes with an Allen wrench and a crescent wrench. There are no settings that have to be maintained during re-assembly.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a side view of a semi-automated cart washing device according to a first embodiment of the invention;

FIG. 2 is a detailed partial sectional view of a wash head having a turbo nozzle in accordance with the invention;

FIG. 3 is a side view of a power head which drives the wash head according to the invention; and

FIG. 4 shows a side view of a fully-automated cart washing device according to a second embodiment of the invention.

### DESCRIPTION OF THE PREFERRED EMBODIMENTS

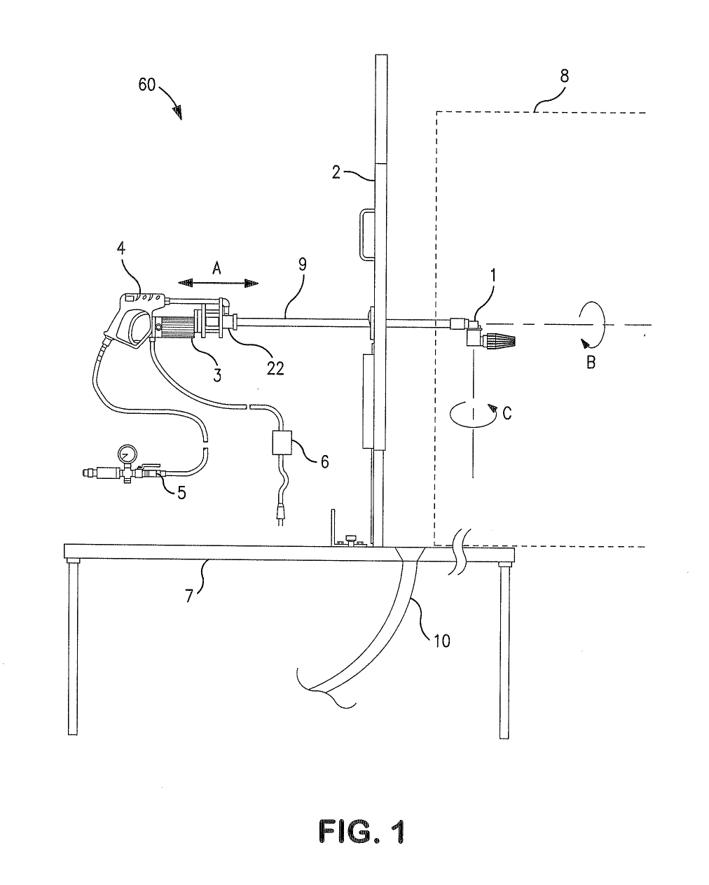

Referring now to the drawings, in which identical or corresponding parts are identified with the same reference numeral, and more particularly to FIG. 1, a first embodiment of a semi-automatic cart washing device of the present invention is designated generally at 60 and includes a wash head 1 on the end of a scanning wand 9, a splash guard 2, a power head 3, a water gun 4, a water circuit 5, a power supply 6, and a cart table 7. A cart 8, shown in phantom, is supported on the cart table 7 in a horizontal position. The cart table can be provided with a drainage system 10 to remove water away from the cart table 7 during cart washing.

An operator (not shown) by handling the water gun 4, manually extends the scanning wand 9 into and out of the cart 8 supported on the cart table 7. Meanwhile water is supplied through the water circuit 5 to an inlet 22a of the water gun 4, which is connected to the scanning wand 9. It will be understood by those skilled in the art that the splash guard 2 guides the scanning wand 9, via a guide bearing (not shown), in a linear manner so as to allow a reciprocating motion in a horizontal plane as indicated by arrow A. The power head 3 is connected to the scanning wand 9 in a manner to be described hereinafter, which causes the wash head 1 to rotate in two planes, as indicated by arrows B and C.

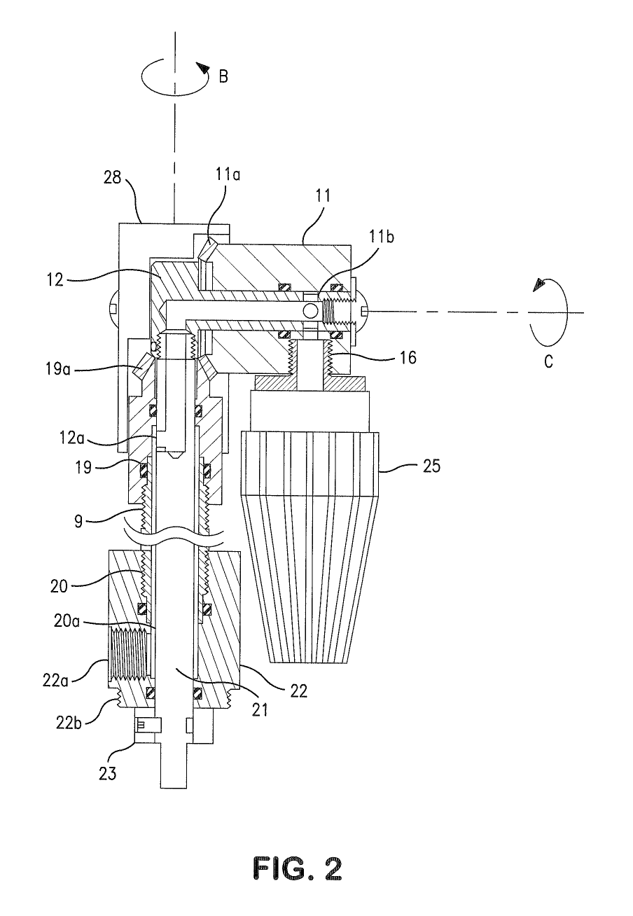

Referring now to FIG. 2, the details of the wash head 1 will be described. The scanning wand 9, which is an element of the wash head 1, is comprised of a stainless steel shaft 21, which is connected to the power head 3 in a manner to be described hereinafter, rotatably mounted inside of a stainless steel tube 20. A lower housing 22 is screwed by threads 22b and fixed to the power head 3 at collar 23 via a set screw (not shown). Water enters the lower housing 22 from the water gun 4 at the inlet 22a of the lower housing 22 (see FIG. 1 also), and flows in an annular space 20a between the rotatable shaft 21 and the tube 20. Water then flows to cross-drilled holes 12a in a main housing 12 that rotates with the shaft 21. An upper housing 19 has an integral stationary, preferably brass bevel pinion gear 19a which mates with a larger rotating, preferably brass, bevel gear 11a which is integral with a nozzle housing 11. A plastic gear cover 28 prevents debris from contaminating the gearing. Water then flows from the main housing 12 out of cross-drilled holes 11b in the nozzle housing 11. From there the water enters the turbo nozzle 25 via a nipple 16.

It will be understood that due to the gearing provided in the wash head 1, and the connection of the gearing with the rotating shaft 21, the turbo nozzle 25 is rotated in 2 planes, as indicated by arrows B and C. These motions in conjunction with the translatory, reciprocating movement of the scanning wand 9 caused by the operator handling the water gun 4 and indicated by arrow A (FIG. 1), ensure that all surfaces of the interior of the cart 8 will be thoroughly cleansed.

An especially preferable embodiment of the invention calls for a gear ratio of 0.545:1 with 24 and 44 teeth respectively provided on the bevel pinion gear 19 and the bevel gear 11, which provides a non-repeating path for the wash head 1 and the translation of the wash head 1 in and out of a cart 8 to clean it more quickly.

Injectors (not shown) are provided to introduce detergents, disinfectants, and/or deodorants during the wash cycle through appropriate connecting hoses and valve attached to the wash head at the lower housing. The water connection at the water circuit 5 is a ⅜ inch female NPT fitting on a porous bronze element filter that keeps scale from entering the nozzle. Normal cycle time is 1-2 minutes for the cart interior. A built-in pressure gauge monitors system performance. Wash results and cycle times may vary due to characteristics of the customer-furnished water circuit and water gun (pressure washer).

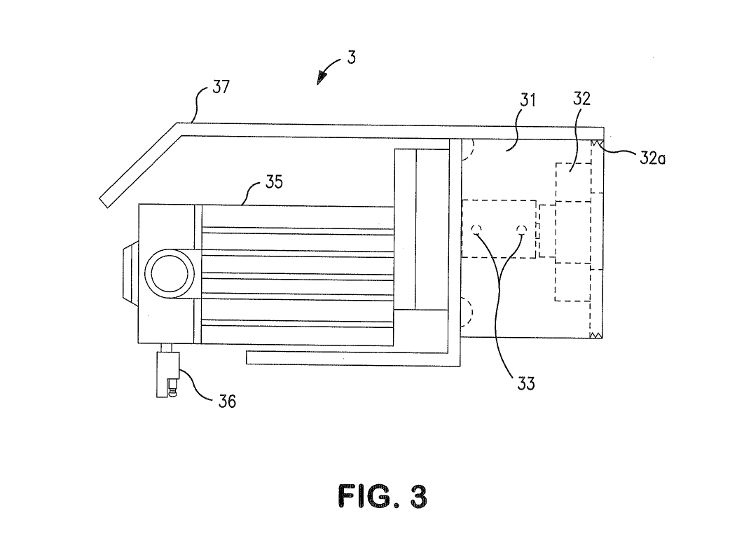

Referring now also to FIG. 3, the power head 3 will be described. The power head 3 includes a motor support 31, a coupling 32, which includes mating threads 32a which cooperate with the threads 22b on the lower housing 22 of the wash head 1, and set screws 33 which secure the shaft 21 of the wash head 1 to a motor shaft (not shown) of a motor 35 of the power head 3. An electrical connector is provided to attach to the power source 6, and a bracket 37 is provided to mount the power head 3 to the water gun 4, in a manner which will be understood by those skilled in the art.

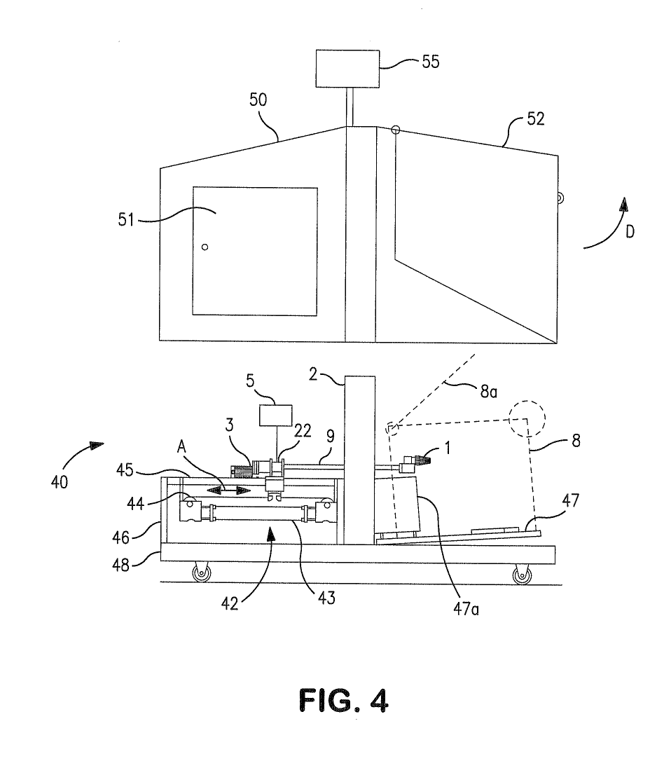

Referring now to FIG. 4, an alternative embodiment of the invention is shown, which depicts a fully automated version of a cart washing system 40. Similarly to the semi-automated cart washing device 60 described heretofore, the system includes a wash head 1, a scanning wand 9, a slash guard 2, a power head 3, and in this case a portable base 48, rather than a cart table. Water is supplied via a water circuit 5, shown schematically, to the lower housing 22 of the wash head 1. Instead of the manual reciprocation of the scanning wand 9 by the operator, the fully automated system 40 is provided with a mechanical drive device 42, which is shown in this case as an actuating cylinder 43 and a connected pulley drive 44 which translates a linear motion from the cylinder 43 to the power head 3, as indicated by arrow A. The power head is slidably mounted in this case on a track 45 which is supported on the base 48 by a support bracket 46. As in the semi-automated cart washing device 60, the scanning wand 9 is guided linearly by a guide bearing (not shown) in the splash guard 2. A platform 47 is provided to mount a cart 8, shown in phantom with an open lid 8a, onto and into the cart washing system 40. The platform 47 is on an incline so that water sprayed from the turbo nozzle 45 into the cart 8 will drain downward toward a drainage system 10, for example as shown in FIG. 1. A front support 47a assists in supporting and holding the cart 8 in place during washing.

The cart washing system 40 further includes an exterior housing 50, which is shown removed from the portable base 48 in the drawing. The housing 50 has an access door 51 which allows for access into a machine compartment formed by the base 48, the splash guard 2, and the housing, which houses the mechanical drive device 42, and as will be understood, all of the associated electrical, water, and air infrastructure necessary to supply and control the cart washing system 40. A side door 52 pivots up to open as indicated by arrow D, to allow a cart 8 to be loaded in to the housing 50 into a washing compartment formed by the base 48, the splash guard 2, and the housing 50. The door 52 is left in a closed position during washing to keep water contained in the housing. A control panel 55 is shown schematically which allows the operator to select the desired operating functions.

An alternative embodiment provides a model with a shortened head profile and conventional ⅛″ nozzles can be used for cleaning drums and casks using the same gear head, which fit into a bung provided at the top thereof which accesses the interior of the drums and casks.

It will be understood that water to the wash head may be shut off and diverted to the water gun in the semi-automated cart washing device, by turning a ball valve (not shown) to a 90° position for washing the cart exterior while in position on the table. Normal cycle time for the exterior is one minute. The fully automated cart washing system has fixed nozzles (not shown) inside the enclosed exterior housing to wash the exterior of a cart while the cart is in place. For operator safety, the motor is driven by a 115 VAC input modular 24 VDC power supply. This is intrinsically safe since there is no high voltage at the wash area. A water motor and air motor are an option to the DC electric motor.

The foregoing relates to a preferred exemplary embodiments of the invention, it being understood that other variants and embodiments thereof are possible within the spirit and scope of the invention, the latter being defined by the appended claims.

We claim:

1. A container washing device for washing an interior of a stationary container, comprising:
a wash head (1) being attached to a pressurized water source (4) at a water inlet (22a) of the wash head (1), the wash head (1) including a wand (9) and having a spray nozzle (25) on an end thereof, a rotatable shaft (21) disposed in the wand (9), a gear train (19a, 11a) connected to the shaft, and a water conduit (20a, 12a, 11b) disposed in the wash head from the water inlet (22a) to the spray nozzle (25);
a power head (3) connected to the wash head (1) at an end of the wand (9) opposite from the spray nozzle (25), the power head (3) having a power supply (6) for a motor (35) which drives the rotatable shaft (21) disposed in the wand (9); and
reciprocating means for linearly reciprocating the wash head (1) and the power head (3) are relative to the container (8) to be washed in order to extend the wash head (1) into and out from the interior of the container (8), wherein the gear train of the wash head (1) enables the spray nozzle (25) to be rotated relative to the wand (9) in two different planes which are orthogonal to an axis of the wand (9).
